(19) United States
(12) Patent Application Publication
(10) Pub. No.: US 2026/0132852 A1
(43) Pub. Date: May 14, 2026

(54) SYSTEMS AND METHODS FOR JOINTING LARGE DIAMOND BILLETS

(71) Applicant: SCHLUMBERGER TECHNOLOGY CORPORATION, Sugar Land, TX (US)

(72) Inventors: David WAHLQUIST, Provo, UT (US); Lynn BELNAP, Provo, UT (US); Frederic PAUCHET, Clamart (FR); Abinesh GNANAVELU, Longford (IE); Jerry MARTINO, Houston, TX (US); J. Daniel BELNAP, Provo, UT (US); David QUIN, Longford (IE); James KENNY, Longford (IE); Declan ELLIOTT, Longford (IE)

(21) Appl. No.: 19/105,350

(22) PCT Filed: Aug. 30, 2024
(86) PCT No.: PCT/US2024/044678

§ 371 Date: Feb. 21, 2025

Related U.S. Application Data
(60) Provisional application No. 63/535,516, filed on Aug. 30, 2023.

(51) Int. Cl. F16K 1/12; B23K 26/38; F16K 25/00

(52) U.S. Cl. CPC F16K 1/12; B23K 26/38; F16K 25/005

(57) ABSTRACT

A device may include a needle having a taper surface toward a distal end and a proximal portion opposite the distal end in an axial direction, wherein a surface of the needle includes polycrystalline diamond. A device may include a base including a non-diamond material positioned around the proximal portion, wherein the base is joined to the proximal portion of the needle by a compression fit.

### CROSS-REFERENCE TO RELATED APPLICATIONS

This application claims priority to and the benefit of U.S. Provisional Patent Application No. 63/535516 filed Aug. 30, 2023 entitled SYSTEMS AND METHODS FOR JOINTING LARGE DIAMOND BILLETS, the subject matter of which is incorporated herein by reference in its entirety.

### BACKGROUND

Large diamond billets have exceptional wear resistance, which when made with diamond material with reliable mechanical properties can be employed to make components of exceptional utility and value. Coupling the large diamond billet or components made from the large diamond billet to other components is challenging due to the hardness of the diamond limiting machining options, the coefficient of thermal expansion of the diamond limiting adhesive and brazing joints, the reactivity of the diamond limiting welding and other heat-based joining techniques, and other factors.

### SUMMARY

In some aspects, the techniques described herein relate to a device including: a needle having a taper surface toward a distal end and a proximal portion opposite the distal end in an axial direction, wherein a surface of the needle includes polycrystalline diamond; and a base including a non-diamond material positioned around the proximal portion, wherein the base is joined to the proximal portion of the needle by a compression fit.

In some aspects, the techniques described herein relate to a device including: a needle having a taper surface toward a distal end and a proximal portion opposite the distal end in an axial direction, wherein a surface of the needle includes polycrystalline diamond; a base including a non-diamond material; diamond threads positioned in the surface including polycrystalline diamond on the proximal portion of the needle; and base threads positioned on the base and complementarily mated to the diamond threads.

In some aspects, the techniques described herein relate to a method of joining diamond, the method including: machining diamond threads in a monolithic diamond billet; forming base threads in a base; and threading the diamond threads into the base threads.

In some aspects, the techniques described herein relate to a method of joining diamond, the method including: inserting a proximal portion of a diamond billet into a base such that at least a portion of the base is circumferentially around the proximal portion; and compressing the proximal portion of the diamond billet with the base.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and aspects of embodiments of the disclosure will be set forth in the description which follows, and in part will be obvious from the description, or may be learned by the practice of such embodiments. The features and aspects of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, non-schematic drawings should be considered as being to scale for some embodiments of the present disclosure, but not to scale for other embodiments contemplated herein. Understanding that the drawings depict some example embodiments, the embodiments will be described and explained with additional specificity and detail through the use of the accompanying drawings in which:

FIG. 1 is a side cross-sectional view of a choke valve in an open position.

FIG. 2 is a side cross-sectional view of a choke valve with a large diamond needle, according to at least some embodiments of the present disclosure.

FIG. 3-1 is a side cross-sectional view of a choke valve with a large diamond needle in an open position, according to at least some embodiments of the present disclosure.

FIG. 3-2 is a side cross-sectional view of a choke valve with a large diamond needle with pressure balancing features, according to at least some embodiments of the present disclosure.

FIG. 4 is a side cross-sectional view of a large diamond needle with threads, according to at least some embodiments of the present disclosure.

FIG. 5 is a side cross-sectional view of a large diamond needle with threads and pressure balancing features, according to at least some embodiments of the present disclosure.

FIG. 6-1 through FIG. 6-3 is a side cross-sectional view of a large diamond billet conforming a complementary threaded base to diamond threads, according to at least some embodiments of the present disclosure.

FIG. 7-1 and FIG. 7-2 is a side cross-sectional view of a base thread conforming during mating, according to at least some embodiments of the present disclosure.

FIG. 8-1 is a side view of laser machining threads in a large diamond billet, according to at least some embodiments of the present disclosure.

FIG. 8-2 is a side cross-sectional view of a large diamond billet, according to at least some embodiments of the present disclosure.

FIG. 9 is a perspective cross-sectional view of a choke valve with a segmented needle and segmented seat, according to at least some embodiments of the present disclosure.

FIG. 10 is a perspective cross-sectional view of a needle with a gasket, according to at least some embodiments of the present disclosure.

FIG. 11 is a perspective cross-sectional view of a needle with a tapered thread portion, according to at least some embodiments of the present disclosure.

FIG. 12 is a perspective cross-sectional view of a needle including a cutting element, according to at least some embodiments of the present disclosure.

### DETAILED DESCRIPTION

Embodiments of the present disclosure generally relate to devices, systems, and methods for the coupling or fixation of a large diamond billet to a non-diamond base. More particularly, some embodiments of the present disclosure relate to coupling or fixing a large diamond billet to a metal or metal alloy base that has a dissimilar coefficient of thermal expansion and/or dissimilar microstructure to the diamond billet. A large diamond billet is a polycrystalline diamond compact (PDC) that is formed in a monolithic body. The microstructure is substantially continuous through the diamond billet with no seams, connections, or joints. In some embodiments, the large diamond billet is formed in a single high-temperature, high-pressure sintering process that produces a solid, monolithic PDC body of greater than 1.0 cubic centimeters (cc). In some embodiments, the large diamond billet has a length of at least 10 millimeters (mm). In some embodiments, the large diamond billet has a length of at least 10 mm and width of at least 10 mm. In some embodiments, the large diamond billet is cylindrical and has an axial length of at least 10 mm. In some embodiments, the large diamond billet is cylindrical and has an axial length of at least 10 mm and a diameter of at least 10 mm. To achieve reasonable manufacturing yields and sufficient reliability in service, in some embodiments, the PDC billet is comprised of material with a flexural strength of greater than 800 megapascals (MPa), a fracture toughness greater than 8 MPa/m, and diamond volume fraction of greater than 90 vol %. PDC material meeting these requirements was determined to have an average grain size between 15-25 microns, such as measured by electron backscatter diffraction (EBSD). To achieve consistency throughout the large-volume PDC billet, it is further preferred that the second phase is comprised essentially of a pure cobalt solvent catalyst that is infiltrated during high-pressure, high-temperature conditions of 1400-1500C and 5.5-7.0 GPa in a vacuum-sealed container. Further, it is desirable for the PDC billet to be heat treated to produce a residual stress relaxation of 100-500 MPa as measured by Raman spectroscopy.

In some embodiments, the diamond billet exhibits a coefficient of thermal expansion (CTE) of approximately 1.1 to 1.2 microns per meter-Celsius (μm/m° C.). Coupling or fixing the diamond billet to a metal or metal alloy component presents a challenge using conventional brazing or other bonding techniques given the difference in CTE between the diamond billet and a metal or metal alloy base. In at least one example, steel exhibits a CTE approximate an order of magnitude greater than diamond at between approximately 10 and 17.3 μm/m° C. During operation, components can experience relatively large changes in temperature, and components including a diamond billet bonded or brazed to a metal base can experience cracking or joint failures due at least partially to strain produced by the difference in CTE. Smaller diamond billets experience lower strain across a contact surface and may be brazed or otherwise bonded to non-diamond components, while brazing or bonding of large diamond billets, as described herein, is unviable in demanding applications.

Diamond component geometries and joining methods according to some embodiments of the present disclosure allow mechanical joining of a large diamond billet to a metal or metal alloy component. More particularly, some embodiments of components described herein provide mechanical joining of a large diamond billet to a metal base where the component experiences a tension force during operation. For example, a choke valve in a surface drilling rig, downhole component, or other portion of a drilling system experiences high fluid pressure differentials, and the flow of the fluid through the choke valve can erode the seat and/or the needle of the choke valve. A seat and/or needle of the choke valve including or made of PDC, such as a large diamond billet, can limit and/or prevent erosion in the choke valve.

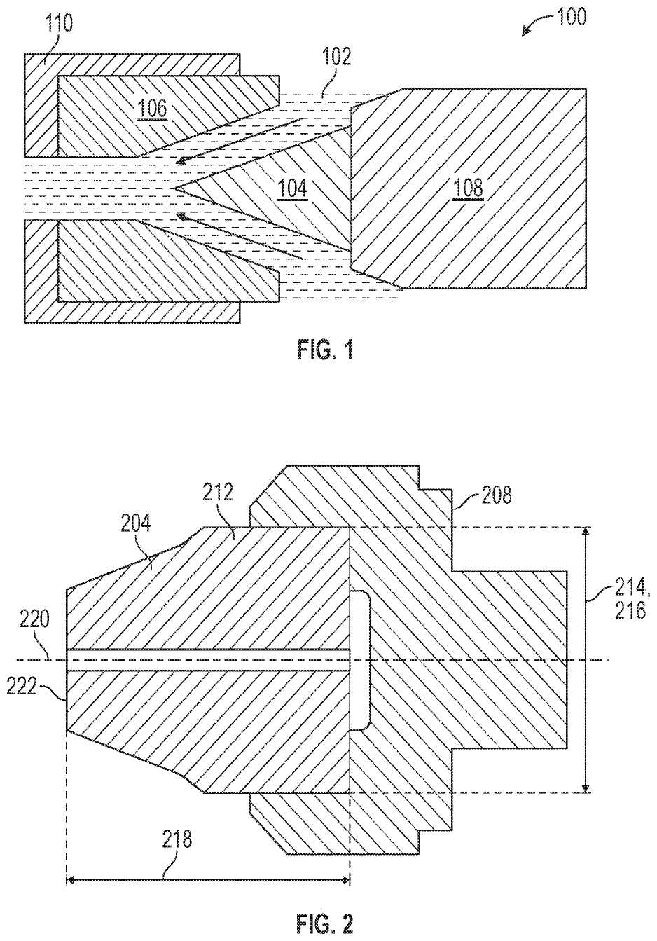

FIG. 1 is a side cross-sectional view of an embodiment of a choke valve 100 with fluid 102 flowing therethrough. In the open position, fluid 102 flows through the choke valve 100 by flowing around the needle 104 and through the annular seat 106 of the choke valve 100. Moving the needle 104 relative to the seat 106 in an axial direction changes the cross-sectional area of the annular space between the needle 104 and the seat 106, which adjusts the pressure differential and flow rate of fluid 102 through the choke valve 100. In some instances when the choke valve 100 is positioned in an open position, but with the needle 104 close to the seat 106, the flow rate and erosive energy of the fluid 102 can damage the needle 104, the seat 106, a base 108 connected to the needle 104, or other components of the choke valve 100.

In some embodiments, one or both of the needle 104 and seat 106 include or are made of a large diamond billet. In some embodiments, the flow direction of the fluid 102 through the choke valve 100 applies a drag force and/or surface pressure to the seat 106 that compresses the seat 106 toward a body 110 of the choke valve 100 that supports the seat 106. In some embodiments, the flow direction of the fluid 102 through the choke valve 100 applies a drag force to the needle 104 and/or generates a low-pressure region downstream of the needle 104 that applies a tension force to a connection between the needle 104 and the base 108. For at least the reasons described herein, the connection between a large diamond billet needle 104 and a metal or metal alloy base 108 presents a challenge. In contrast to tool steel or tungsten carbide, a diamond billet resists conventional machining of threads, cannot be welded, and has other joining challenges. In some embodiments according to the present disclosure, a large diamond billet needle is coupled to a non-diamond (e.g., metal or metal alloy) base by a mechanical joint, such as a shrink fit or a threaded connection, which may include one or more pressure balancing features.

Diamond exhibits advantageous properties, such as wear resistance, strength, toughness, a low coefficient of friction, and a low CTE. However, diamond can be challenging to machine, press, or otherwise form into a desired geometry. In some embodiments, a needle and/or needle and base include one or more features to provide more robust connections between a large diamond billet and another component. It should be understood that while the present disclosure refers to a diamond billet and/or large diamond billet, the connections and connection methods described herein are equally applicable to needles and other components with a surface or layer including polycrystalline diamond. For example, a tungsten core with a diamond outer surface or layer may exhibit the same or similar joining challenges to the diamond billets described herein. Any embodiment of a device including a diamond billet describe herein (e.g., in relation to FIG. 2 through 11) may include an element (such as a needle or seat) that includes a surface or layer including polycrystalline diamond on a non-diamond body.

FIG. 2 is a side cross-sectional view of an embodiment of a large diamond needle 204 connected to a metal or metal alloy base 208. It should be understood that while the present disclosure will refer to embodiments and examples of components used in a choke valve, the diamond joining geometries and techniques described herein are applicable to other components, such as diamond anvils, diamond nozzles, diamond cutting elements, and other diamond elements joined to non-diamond bases.

The large diamond needle 204, in some embodiments, is joined to the metal alloy base 208 by a shrink fit and/or compression fit around a proximal portion 212 of the large diamond needle 204. In some embodiments, the base 208 is heated to a temperature greater than an expected operating temperature to expand an inner diameter 214 of the base 208 larger than the outer diameter 216 to receive the proximal portion 212 of the large diamond needle 204. Upon cooling, the base 208 contracts and compresses the proximal portion 212 of the large diamond needle 204 to retain the large diamond needle 204 in the base. In some embodiments, the proximal portion 212 contacts and is compressed by the base 208 along at least 25% of a length 218 of the large diamond needle 204 in the axial direction 220. In some embodiments, the proximal portion 212 contacts and is compressed by the base 208 along at least 30% of the length 218 of the large diamond needle 204 in the axial direction 220. In some embodiments, the proximal portion 212 contacts and is compressed by the base 208 along at least 40% of the length 218 of the large diamond needle 204 in the axial direction 220.

In some embodiments, the large diamond needle 204 has a truncated distal end 222 opposite the proximal portion 212 and distal to the base 208 in the axial direction 220. In a conventional material, a distal end tapers to an approximate point to allow fluid flow past the needle with limited erosion and/or turbulence at the distal end. In some embodiments, a large diamond needle 204 has sufficient wear and/or erosive resistance that a truncated distal end 222 allows the use of a large diamond needle 204 with a shorter overall length 218 without substantial erosion, which may reduce manufacturing costs and/or operational costs and increase manufacturing yields of the large diamond billets.

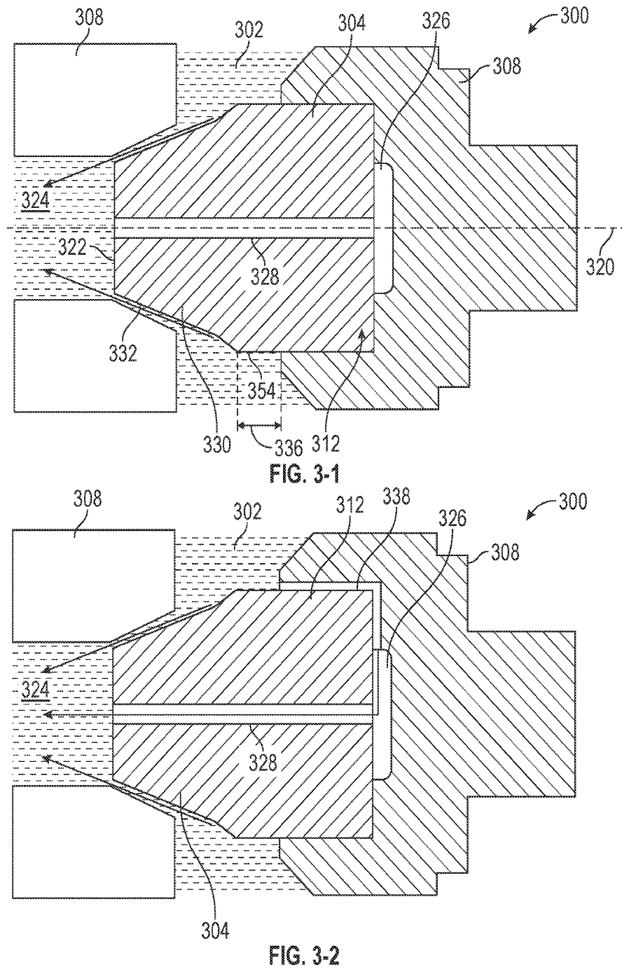

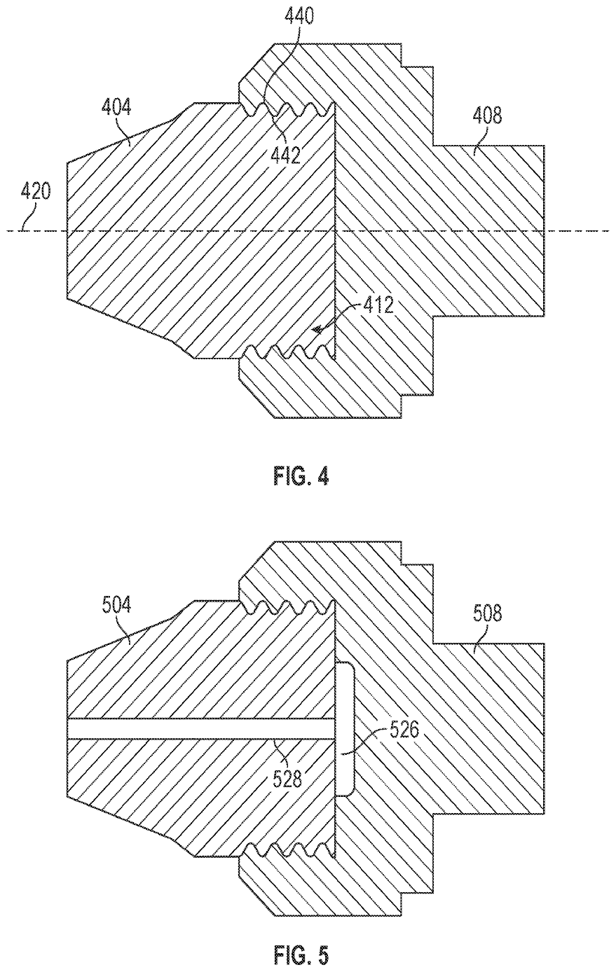

While the large diamond needle 204 exhibits relatively high erosion resistance, other components, such as the base 208, are more susceptible to erosion. FIG. 3-1 and FIG. 3-2 illustrate embodiments of erosion-limiting and/or pressure-balancing features. FIG. 3-1 is a side cross-sectional view of an embodiment of a choke valve 300 including a large diamond needle 304 and a diamond seat 306 in an open position. While fluid 302 flows through the space between the needle 304 and the seat 306, the pressure difference across the choke valve 300 creates a low-pressure region 324 at the distal end 322 of the needle 304. In some embodiments, the low-pressure region 324 applies a force to the truncated distal end 322 of the needle 304, pulling the needle 304 in the axial direction 320 away from the base 308.

In some embodiments, the large diamond needle 304 and/or base 308 include one or more pressure-balancing features to limit and/or prevent a disconnection of the needle 304 from the base 308. For example, the base 308, in some embodiments, includes a pressure-balancing volume 326 positioned adjacent to the proximal portion 312 of the needle 304 in the axial direction 320. The pressure-balancing volume 326 may allow a portion of the fluid 302 to flow between the proximal portion 312 and the base 308 and through a pressure-balancing bore 328 in the needle 304. While a conventional needle is solid (e.g., without a bore) to prevent fluid flow through the needle while the choke valve is in a closed position, embodiments of a large diamond needle 304, according to present disclosure, including a pressure-balancing bore 328 can allow the choke valve 300 to “leak” fluid 302 therethrough to limit and/or prevent a catastrophic failure in which the diamond needle 304 disconnects from the base 308. In some embodiments, in a closed position, the choke valve 300 will leak fluid 302 in a detectable manner before failure, allowing detection and repair before a catastrophic failure. In some embodiments, the pressure-balancing bore 328 is electrical discharge machined (EDM) in the needle 304.

For example, the relatively wear-prone metal of the base 308 may wear around the proximal portion 312 at a higher rate than the diamond needle 304, causing ingress of fluid 302 to the proximal end of the needle 304. A pressure-balancing bore 328 allows the flow of the fluid 302 away from the proximal end to the low-pressure region 324 to reduce the pressure difference. In some embodiments, the needle 304 includes erosion limiting features on a surface thereof to limit and/or prevent erosion of the base 308 proximate the needle 304.

In some embodiments, the needle 304 has a deflection surface 330 between a taper surface 332 of the needle 304 and a radially outermost surface 334 of the needle 304. The deflection surface 334 is oriented at a higher angle to the axial direction 320 than the taper surface 332 to deflect fluid flow away from the base 308 at the proximal portion 312 of the needle 304. In some embodiments, the deflection surface 330 limits the exposure of the base 308 to the regions of highest flowrate of the fluid 302.

In some embodiments, a standoff 336 in the axial direction 320 between the deflection surface 330 and/or the taper surface 332 of the needle 304 and the base 308 limits the exposure of the base 308 to the regions of highest flowrate of the fluid 302. In some embodiments, the standoff 336 is at least 10% of a length of the needle in the axial direction 320. In some embodiments, the standoff 336 is at least 20% of a length of the needle in the axial direction 320. In some embodiments, the standoff 336 is at least 30% of a length of the needle in the axial direction 320.

FIG. 3-2 is a side cross-sectional view of the embodiment of a choke valve 300 of FIG. 3-1 with fluid ingress to the pressure-balancing volume 326. In some embodiments, fluid 302 is able to flow between the proximal portion 312 of the needle 304 and the base 308. The fluid 302 may erode a portion of the base 308 to open a leak channel 338 to the pressure-balancing volume 326 proximate the rear surface of the needle 304. In some embodiments, the pressure-balancing volume provides fluid communication to the low-pressure region 324 via the pressure-balancing bore 328 to lessen a pressure difference across the choke valve 300. In some embodiments, as described herein, the leak through the leak channel 338 is detectable to provide a controlled and detectable failure prior to a catastrophic failure of the base 308 holding the large diamond needle 304.

In some embodiments, the leak channel 338 begins due to a machining imperfection and/or tolerance of the needle 304 and/or base 308. In at least one embodiment, machining a large diamond billet to a precise dimension and/or consistent dimension across a surface of the large diamond is challenging. For example, diamond is one of the hardest materials known, and variations in surface dimensions or geometry may be difficult to control.

FIG. 4 is a side cross-sectional view of a threaded connection between a large diamond needle 404 and a non-diamond base 408. As described herein, while the present disclosure will refer to embodiments and examples of components used in a choke valve, the diamond joining geometries and techniques described herein are applicable to other components, such as diamond anvils, diamond nozzles, diamond cutting elements, and other diamond elements joined to non-diamond bases. In some embodiments, the large diamond billet includes diamond threads 440 on a radially outward surface of a proximal portion 412 of the large diamond billet, such as the large diamond needle 404, relative to an axial direction 420. In some embodiments, the diamond threads 440 complementarily mate with base threads 442 on the base 408. The threaded connection of the diamond threads 440 and the base threads 442, upon torquing the threaded connection together, applies a compressive force between the needle 404 and the base 408 to counteract the pressure difference across the choke valve, such as described in relation to FIG. 3-1 and FIG. 3-2.

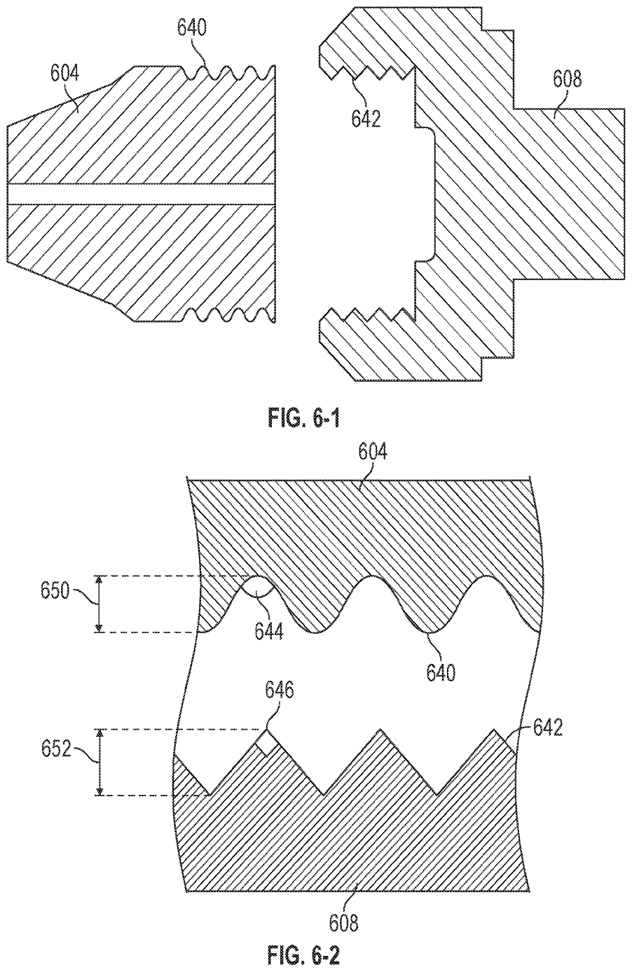

FIG. 5 is a side cross-sectional view of a threaded connection between a large diamond needle 504 and a non-diamond base 508 with pressure-balancing features. In some embodiments, the threaded connection of the needle 504 and the base 508 limits and/or prevents the formation of a leak channel, such as that described in relation to FIG. 3-2. In some embodiments, the threaded connection of the needle 504 and the base 508 limits and/or prevents a catastrophic failure (e.g., release) of the needle 504 from the base 508. In some embodiments, a leak channel may still form, and the needle 504 and/or base 508 with a pressure-balancing volume 526 and pressure-balancing bore 528 allows the controlled failure of the choke valve and detection of the erosion prior to a catastrophic failure.

FIG. 6-1 through FIG. 6-3 illustrate an embodiment of a method of manufacturing a large diamond needle with a threaded connection. In some embodiments, the needle 604 has diamond threads 640 and the base 608 has base threads 642. In some embodiments, the diamond threads 640 and the base threads 642 have substantially the same pitch but vary in shape and/or depth. In some embodiments, mating the diamond threads 640 and the base threads 642 plastically deforms the base threads 642 to at least partially match the diamond threads 640. As machining the diamond of the large diamond needle 604 is challenging, the base threads 642, in some embodiments, conform to the diamond threads 640 and any variations therein.

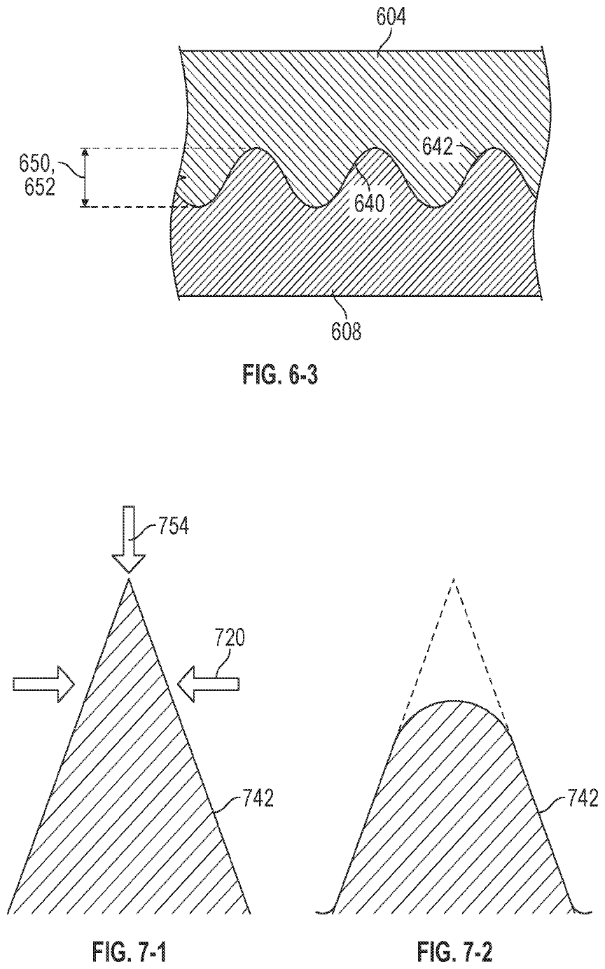

Referring now to FIG. 6-2, in some embodiments, the diamond threads 640 of the needle 604 have a diamond radius of curvature (ROC) 644 that is different from a base ROC 646 of the base threads 642 on the base 608. For example, while diamond has a relatively high toughness, the microstructure of the diamond billet may have residual strain therein, and avoidance of stress risers and stress concentrations in the large diamond needle 604 and diamond threads 640 is beneficial. In some embodiments, the diamond ROC is at least 10% of a diamond thread depth 650. In some embodiments, the diamond ROC is at least 15% of a diamond thread depth 650. In some embodiments, the diamond ROC is at least 20% of a diamond thread depth 650. In some embodiments, the diamond ROC is at least 25% of a diamond thread depth 650.

In some embodiments, the diamond threads 640 of the needle 604 have a diamond ROC 644 that is greater than a base ROC 646 of the base threads 642 on the base 608. In some embodiments, the diamond ROC 644 is the same at the end of the diamond threads and the troughs between the diamond threads 640. In some embodiments, a diamond thread depth 650 is different from a base thread depth 652. In some embodiments, the diamond thread depth 650 is less than the base thread depth 652.

In some embodiments, the harder and tougher diamond of the diamond threads 640 cold-works or cold-forges the metal of the base 608 to change a shape of the base threads 642 without heating the base threads 642 prior to threading the connection together. In some embodiments, the base threads 642 exhibit a cold-forged microstructure after mating to the diamond threads 640. In some embodiments, a ferrous base material can react with the diamond to create carbide phases in the diamond when the diamond is exposed to iron at an elevated temperature. By mating the connection and deforming the base material at ambient temperature, carbide phases can be avoided. In some embodiments, the relatively low coefficient of friction of the diamond further limits the temperature increase during the mating of the threaded connection, limiting and/or preventing the formation of carbide phases.

Referring now to FIG. 6-3, in some embodiments, after mating the threaded connection of the needle 604 and the base 608, the base threads 642 substantially match the geometry of the diamond threads 640. For example, the base thread depth 652 changes to substantially equal the diamond thread depth 650. In some embodiments, a base ROC 646 changes to substantially equal the diamond ROC 644.

In some embodiments, an additional material may be located between at least a portion of the diamond threads 640 and the base threads 642. For example, a cement or other filler material may be positioned on one or both threads prior to mating of the base 608 and needle 604. In some embodiments, the cement may facilitate a microstructural bond between the base 608 and the needle 604. In some embodiments, the cement may adhere the base 608 to the needle 604. In some embodiments, a filler material fills in at least one gap between the diamond threads 640 and the base threads 642 to seal the space between the base 608 and the needle 604. Such cement or filler material may limit and/or prevent leakage through the threaded connection between the needle 604 and the base 608.

FIG. 7-1 and FIG. 7-2 illustrate the deformation of an embodiment of a base thread 742 during mating of a diamond billet and base. In some embodiments, the diamond thread compresses the base thread 742 in a radial direction 754, shortening the base thread 742. In some embodiments, compressing the base thread 742 displaces material of the base thread 742 in the axial direction 720, to form the shorter, wider base thread 742 of FIG. 7-2.

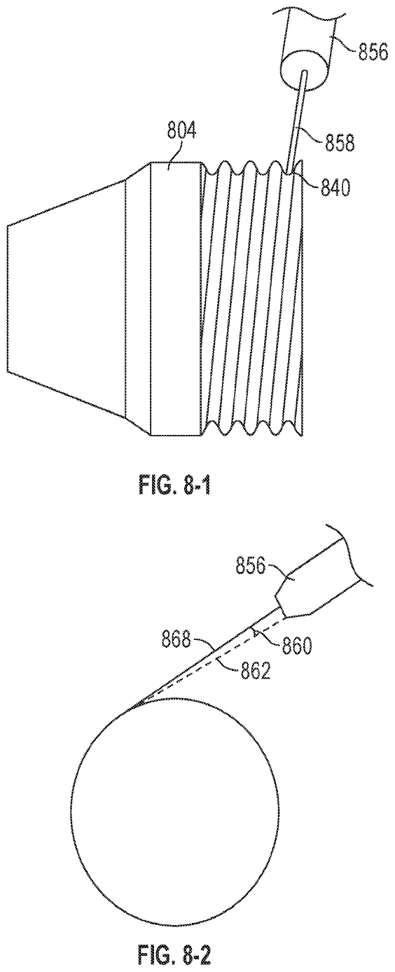

As described herein, machining diamond is challenging. Both lapping and grinding can form surfaces in the diamond billet, but cannot form detailed geometries, such as threads. In some embodiments, the diamond threads are formed in the large diamond billet by laser machining, such as laser ablation. FIG. 8-1 is a perspective view of laser machining a diamond thread in a large diamond billet. In some embodiments, laser machining can induce heat-affected zones that graphitize the diamond. Graphitizing the diamond changes the microstructure from a cubic crystalline structure to a planar crystalline structure, substantially altering the hardness and toughness of the material. In some embodiments, the laser machining can oxidize the diamond, further damaging the microstructure.

In some embodiments, according to the present disclosure, a large diamond needle 804 or other large diamond billet is laser machined by a laser source 856 positioned with the laser 858 substantially tangential to the diamond thread 840 being machined. For example, FIG. 8-2 is an end view of the embodiment of a needle 804 and laser source 856 of FIG. 8-1 in which the laser 858 is oriented at an angle 860 with a tangent line 862 of less than 20°. In some embodiments, the laser 858 is oriented at an angle 860 with a tangent line 862 of less than 15°. In some embodiments, the laser 858 is oriented at an angle 860 with a tangent line 862 of less than 10°. In some embodiments, the laser 858 is oriented at an angle 860 with a tangent line 862 of less than 5°.

In some embodiments, the substantially tangential laser machining of the diamond threads 840 in diamond limits and/or prevents a heat-affected zone and limits and/or prevents graphitization in the heat-affected zone. However, in some embodiments, some graphitization and/or thermal strain can occur in the diamond microstructure. Abrasive blasting of the diamond threads 840 after laser machining, in some embodiments, removes the graphitized carbon and/or relieves thermal strain in the diamond before the diamond threads are mated to the base threads, such as in any embodiments described in relation to FIG. 5 through 7-2. In some embodiments, the abrasive blasting includes blasting the diamond threads with a silicon carbide abrasive.

While the present disclosure describes methods of manufacturing threads in a diamond needle, it should be understood that at least some embodiments described herein may be used to manufacture threads in other large diamond billets, such as diamond anvils, diamond nozzles, diamond cutting elements, and other diamond elements joined to non-diamond bases.

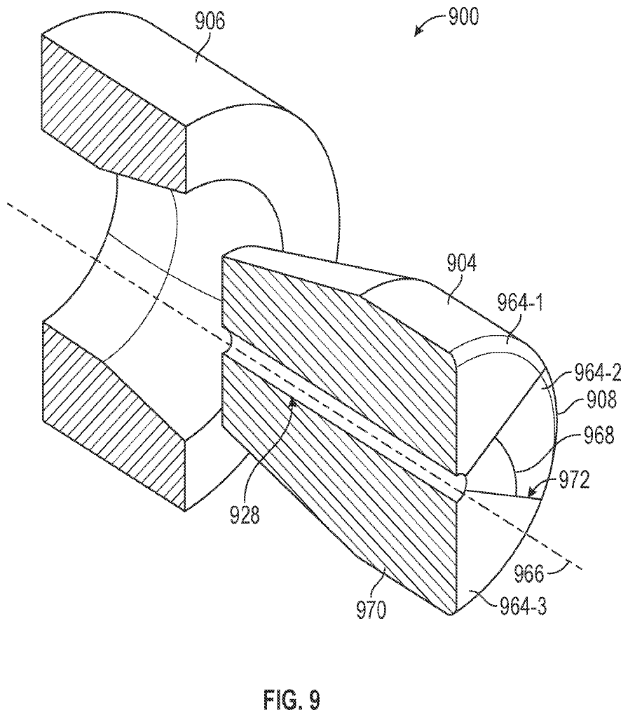

FIG. 9 is a perspective cross-sectional view of an embodiment of a choke valve 900 including a needle 904 and a seat 906. As described herein, machining of diamond materials is challenging and resource intensive. In some embodiments, manufacturing and/or machining diamond to the geometry and/or dimensions of the choke valve 900 is expensive or not possible with a given sintering press. A choke valve 900, in some embodiments, includes a needle 904 and/or a seat 906 having a plurality of monolithic diamond billets as angular segments 964-1, 964-2, 964-3. While the angular segments 964-1, 964-2, 964-3 are described herein as parts of the needle 904, it should be understood that such description is applicable to angular segments of a seat 906.

In some embodiments, the angular segments 964-1, 964-2, 964-3 are each, themselves, diamond billets. For example, each angular segment 964-1, 964-2, 964-3 may be a large diamond billet according to the sintering methods and with the material properties described herein. The angular segments 964-1, 964-2, 964-3 are positioned, in some embodiments, to form the needle 904 in segments around the axial direction 966 of the needle 904. The angular segments 964-1, 964-2, 964-3 combine to form the needle 904 circumferentially around the axial direction 966. In some embodiments, the needle 904 includes at least two angular segments 964-1, 964-2, 964-3. In the illustrated embodiment of FIG. 9, the needle 904 includes a total of six segments with three angular segments 964-1, 964-2, 964-3 illustrated in the cross-sectional view. In some embodiments, angular segments 964-1, 964-2, 964-3 allow simpler machining of a pressure-balancing bore 928 by machining a groove in each of the angular segments 964-1, 964-2, 964-3 that, when assembled in the needle 904, form the pressure-balancing bore 928.

In some embodiments, the angular segments 964-1, 964-2, 964-3 have an arcuate length 968 relative to the axial direction 966. For example, the arcuate length 968 may be measured in degrees and/or percentage of the circumference around the axial direction 966 and perpendicular to the axial direction 966. In some embodiments, the arcuate length 968 of each angular segment 964-1, 964-2, 964-3 of the plurality of angular segments is equal. In some embodiments, an arcuate length 968 of at least one angular segment is different from the arcuate length of a second angular segment.

In some embodiments, the angular segments 964-1, 964-2, 964-3 contact one another interface surfaces 970 at an angular interface 972. The angular interface 972 is, in some embodiments, oriented radially to the axial direction 966. In such embodiments, radial compression from the base 908 (e.g., due to differing CTEs as described herein) produces a compression between the angular segments 964-1, 964-2, 964-3 at the angular interfaces 972.

In some embodiments, the interface surfaces 970 of adjacent angular segments 964-1, 964-2, 964-3 directly contact one another with no other materials therebetween. In some embodiments, the interface surfaces 970 are ground, lapped, or otherwise machined to produce a smooth interface surface 970 and a fluid-tight angular interface 972. In some embodiments, the interface surface 970 has surface texture, surface features, or sintering artifacts that create one or more voids at the angular interface 972 between angular segments 964-1, 964-2, 964-3. In some embodiments, the radial compression of the angular segments 964-1, 964-2, 964-3 at the angular interface 972 deforms the interface surface(s) 970 to create a fluid-tight interface. In some embodiments, the voids or other space between the angular segments 964-1, 964-2, 964-3 allows fluid flow therethrough in the axial direction 966 such that a pressure-balancing bore 928 is not required.

FIG. 9 illustrates an embodiment of a needle 904 that is radially compressed by a base 908. In some embodiments, a needle 904 including a plurality of angular segments 964-1, 964-2, 964-3 includes threads, such as described in relation to FIG. 4 through FIG. 7-2. For example, the diamond threads in the needle may be formed in the angular segments 964-1, 964-2, 964-3 with at least a portion of the threads in each of the angular segments 964-1, 964-2, 964-3. The threads may be formed in the outer surface of the angular segments 964-1, 964-2, 964-3 such that at least one thread is continuous between adjacent angular segments 964-1, 964-2, 964-3.

In some embodiments, an additional material may be located between at least at least two of the angular segments 964-1, 964-2, 964-3. For example, a cement or other filler material may be positioned on one or both interface surfaces 970 at the angular interface 972. In some embodiments, the cement may facilitate a microstructural bond between the angular segments 964-1, 964-2, 964-3. In some embodiments, the cement may adhere the angular segments 964-1, 964-2, 964-3. In some embodiments, a filler material fills in at least one gap between the angular segments 964-1, 964-2, 964-3 to seal the angular interface 972. Such cement or filler material may limit and/or prevent leakage through the angular interface 972 and through the needle 904.

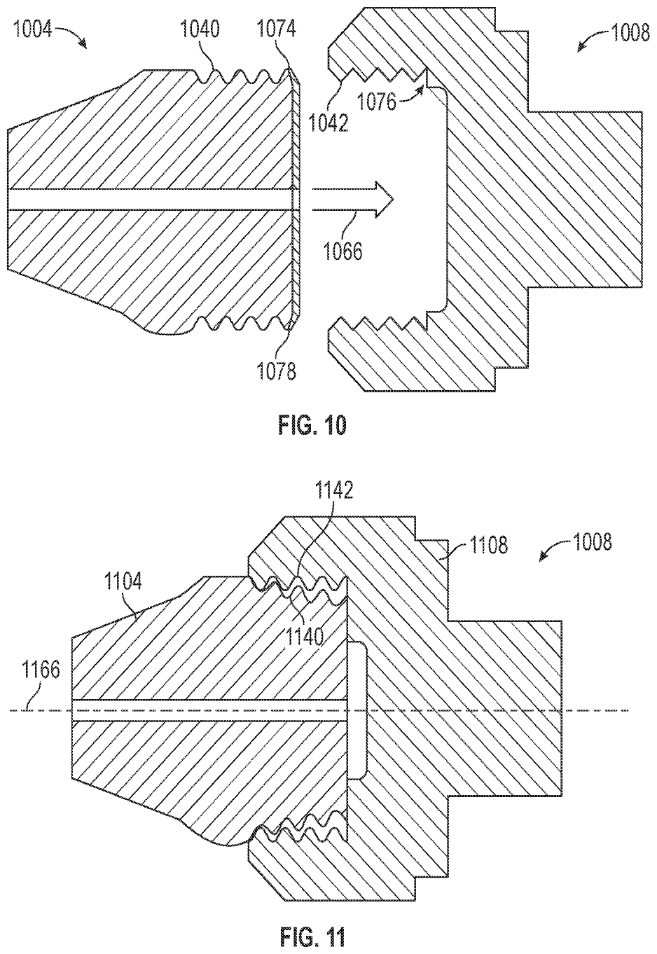

FIG. 10 is a side cross-sectional view of an embodiment of a choke valve 1000 with a seal at a longitudinal end of the needle 1004. The seal may be formed by deformation of a gasket material or deformation of the base material, itself. In some embodiments, the diamond threads 1040 and the base threads 1042 cooperate to apply a force in the axial direction 1066. The axial force applies a compressive force in the axial direction 1066 between a chamfer 1074, curved edge, or other angled edge of the needle 1004 and a circumferential edge 1076 of the base 1008. The circumferential edge 1076 is, in some embodiment, proximate to a pressure-balancing volume or other void in the base 1008 (such as the pressure-balancing volume 526 described in relation to FIG. 5). In some embodiments, the compressive force results in the diamond of the needle 1004 deforming the base material at the circumferential edge 1076 to create a seal that is fluid-tight and ensures any fluid flows through planned channels (such as a pressure-balancing bore).

In some embodiments, the choke valve 1000 further includes a gasket 1078 which is compressible between the needle 1004 and the base 1008 in the axial direction 1066 to further seal the thread portion and limit and/or prevent leakage. In some embodiments, the gasket 1078 includes a polymeric material. In some embodiments, the gasket 1078 includes a plastically-deformable metal. In some embodiments, the gasket 1078 is adhered to the needle 1004. In some embodiments, the gasket 1078 is adhered to the base 1008.

FIG. 11 is a side cross-sectional view of an embodiment of a choke valve 1100 with a tapered needle thread portion to create a seal longitudinally within the thread portion. For example, the needle 1104 is tapered through at least a portion of the diamond threads 1140 in the axial direction 1166. In some embodiments, the needle 1104 and base 1108 are tapered through at least a portion of the diamond threads 1140 and base threads 1142, respectively, in the axial direction 1166. In some embodiments, the tapered thread portion of the needle creates a radially-oriented compression force between the diamond threads 1140 and the base threads 1142 to concentrate the compression force and further facilitate deformation of the base threads 1142. In some embodiments, the base 1108 is tapered in the base thread portion (e.g., the box) to concentrate the compression force and further facilitate deformation of the base threads 1142.

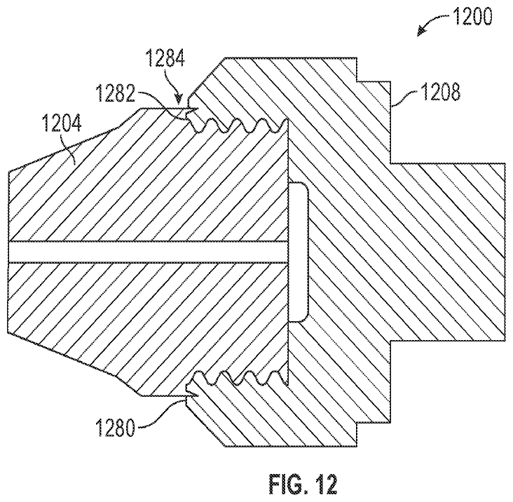

FIG. 12 is a side cross-sectional view of an embodiment of a choke value 1200 in which a cutting face of the needle 1204 and/or base 1208 cuts or deforms a contacting surface to create a seal. In some embodiments, a shoulder surface 1280 of the base 1208 and a flange surface 1282 of the needle 1204 contact one another to limit and/or prevent fluid flow therebetween. In some embodiments, the fluid flow therebetween is further limited by a cutting feature 1284 located on or in the flange surface 1282. The cutting feature 1284 cuts into and/or applies a force to the shoulder surface 1280 of the base 1208 when the needle 1204 is screwed into or otherwise pressed into the base 1208. The cutting feature 1284 may plastically or elastically deform the shoulder surface 1280 to create a fluid seal across the shoulder surface 1280. In some embodiments, the cutting feature 1284 is continuous around a circumference of the flange surface 1282. In some embodiments, the flange surface 1282 has a plurality of discrete cutting elements that plastically or elastically deform the shoulder surface 1280 to create a fluid seal across the shoulder surface 1280.

In at least one embodiment of the present disclosure, a choke valve including a needle and/or seat made of a large diamond billet and/or segments made of large diamond billets has a longer operational lifetime and provides greater uptime relative to conventional steel choke valves.

### INDUSTRIAL APPLICABILITY

Embodiments of the present disclosure generally relate to devices, systems, and methods for the coupling or fixation of a large diamond billet to a non-diamond base. More particularly, some embodiments of the present disclosure relate to coupling or fixing a large diamond billet to a metal or metal alloy base that has a dissimilar coefficient of thermal expansion and/or dissimilar microstructure to the diamond billet. A large diamond billet is a polycrystalline diamond compact (PDC) that is formed in a monolithic body. The microstructure is substantially continuous through the diamond billet with no seams, connections, or joints. In some embodiments, the large diamond billet is formed in a single high-temperature, high-pressure sintering process that produces a solid, monolithic PDC body of greater than 1.0 cubic centimeters (cc). In some embodiments, the large diamond billet has a length of at least 10 millimeters (mm). In some embodiments, the large diamond billet has a length of at least 10 mm and width of at least 10 mm. In some embodiments, the large diamond billet is cylindrical and has an axial length of at least 10 mm. In some embodiments, the large diamond billet is cylindrical and has an axial length of at least 10 mm and a diameter of at least 10 mm.

In some embodiments, the diamond billet exhibits a coefficient of thermal expansion (CTE) of approximately 1.1 to 1.2 microns per meter-Celsius (μm/m ° C.). Coupling or fixing the diamond billet to a metal or metal alloy component presents a challenge using conventional brazing or other bonding techniques given the difference in CTE between the diamond billet and a metal or metal alloy base. In at least one example, steel exhibits a CTE approximate an order of magnitude greater than diamond at between approximately 10 and 17.3 μm/m° C. During operation, components can experience relatively large changes in temperature, and components including a diamond billet bonded or brazed to a metal base can experience cracking or joint failures due at least partially to strain produced by the difference in CTE. Smaller diamond billets experience lower strain across a contact surface and may be brazed or otherwise bonded to non-diamond components, while brazing or bonding of large diamond billets, as described herein, is unviable in demanding applications.

Diamond component geometries and joining methods according to some embodiments of the present disclosure allow mechanical joining of a large diamond billet to a metal or metal alloy component. More particularly, some embodiments of components described herein provide mechanical joining of a large diamond billet to a metal base where the component experiences a tension force during operation. For example, a choke valve in a surface drilling rig, downhole component, or other portion of a drilling system experiences high fluid pressure differentials, and the flow of the fluid through the choke valve can erode the seat and/or the needle of the choke valve. A seat and/or needle of the choke valve including or made of PDC, such as a large diamond billet, can limit and/or prevent erosion in the choke valve.

In the open position, fluid flows through the choke valve by flowing around the needle and through the annular seat of the choke valve. Moving the needle relative to the seat in an axial direction changes the cross-sectional area of the annular space between the needle and the seat, which adjusts the pressure differential and flow rate of fluid through the choke valve. In some instances when the choke valve is positioned in an open position, but with the needle close to the seat, the flow rate and erosive energy of the fluid can damage the needle, the seat, a base connected to the needle, or other components of the choke valve.

In some embodiments, one or both of the needle and seat include or are made of a large diamond billet. In some embodiments, the flow direction of the fluid through the choke valve applies a drag force and/or surface pressure to the seat that compresses the seat toward a body of the choke valve that supports the seat. In some embodiments, the flow direction of the fluid through the choke valve applies a drag force to the needle and/or generates a low-pressure region downstream of the needle that applies a tension force to a connection between the needle and the base. For at least the reasons described herein, the connection between a large diamond billet needle and a metal or metal alloy base presents a challenge. In some embodiments according to the present disclosure, a large diamond billet needle is coupled to a non-diamond (e.g., metal or metal alloy) base by a mechanical joint, such as a shrink fit or a threaded connection, which may include one or more pressure balancing features.

Diamond exhibits advantageous properties, such as wear resistance, strength, toughness, a low coefficient of friction, and a low CTE. However, diamond can be challenging to machine, press, or otherwise form into a desired geometry. In some embodiments, a needle and/or needle and base include one or more features to provide more robust connections between a large diamond billet and another component.

It should be understood that while the present disclosure will refer to embodiments and examples of components used in a choke valve, the diamond joining geometries and techniques described herein are applicable to other components, such as diamond anvils, diamond nozzles, diamond cutting elements, and other diamond elements joined to non-diamond bases.

The large diamond needle, in some embodiments, is joined to the metal alloy base by a shrink fit and/or compression fit around a proximal portion of the large diamond needle. In some embodiments, the base is heated to a temperature greater than an expected operating temperature to expand an inner diameter of the base larger than the outer diameter to receive the proximal portion of the large diamond needle. Upon cooling, the base contracts and compresses the proximal portion of the large diamond needle to retain the large diamond needle in the base. In some embodiments, the proximal portion contacts and is compressed by the base along at least 25% of a length of the large diamond needle in the axial direction. In some embodiments, the proximal portion contacts and is compressed by the base along at least 30% of the length of the large diamond needle in the axial direction. In some embodiments, the proximal portion contacts and is compressed by the base along at least 40% of the length of the large diamond needle in the axial direction.

In some embodiments, the large diamond needle has a truncated distal end opposite the proximal portion and distal to the base in the axial direction. In a conventional material, a distal end tapers to an approximate point to allow fluid flow past the needle with limited erosion and/or turbulence at the distal end. In some embodiments, a large diamond needle has sufficient wear and/or erosive resistance that a truncated distal end allows the use of a large diamond needle with a shorter overall length without substantial erosion, which may reduce manufacturing costs and/or operational costs and increase manufacturing yields of the large diamond billets.

While the large diamond needle exhibits relatively high erosion resistance, other components, such as the base, are more susceptible to erosion. While fluid flows through the space between the needle and the seat, the pressure difference across the choke valve creates a low-pressure region at the distal end of the needle. In some embodiments, the low-pressure region applies a force to the truncated distal end of the needle, pulling the needle in the axial direction away from the base.

In some embodiments, the large diamond needle and/or base include one or more pressure-balancing features to limit and/or prevent a disconnection of the needle from the base 308. For example, the base, in some embodiments, includes a pressure-balancing volume positioned adjacent to the proximal portion of the needle in the axial direction. The pressure-balancing volume may allow a portion of the fluid to flow between the proximal portion and the base and through a pressure-balancing bore in the needle. While a conventional needle is solid (e.g., without a bore) to prevent fluid flow through the needle while the choke valve is in a closed position, embodiments of a large diamond needle, according to present disclosure, including a pressure-balancing bore can allow the choke valve to “leak” fluid therethrough to limit and/or prevent a catastrophic failure in which the diamond needle disconnects from the base. In some embodiments, in a closed position, the choke valve will leak fluid in a detectable manner before failure, allowing detection and repair before a catastrophic failure. In some embodiments, the pressure-balancing bore is electrical discharge machined (EDM) in the needle.

For example, the relatively wear-prone metal of the base may wear around the proximal portion at a higher rate than the diamond needle, causing ingress of fluid to the proximal end of the needle. A pressure-balancing bore allows the flow of the fluid away from the proximal end to the low-pressure region to reduce the pressure difference. In some embodiments, the needle includes erosion limiting features on a surface thereof to limit and/or prevent erosion of the base proximate the needle.

In some embodiments, the needle has a deflection surface between a taper surface of the needle and a radially outermost surface of the needle. The deflection surface is oriented at a higher angle to the axial direction than the taper surface to deflect fluid flow away from the base 308 at the proximal portion of the needle. In some embodiments, the deflection surface limits the exposure of the base to the regions of highest flowrate of the fluid.

In some embodiments, a standoff in the axial direction between the deflection surface and/or the taper surface of the needle and the base limits the exposure of the base to the regions of highest flowrate of the fluid. In some embodiments, the standoff is at least 10% of a length of the needle in the axial direction. In some embodiments, the standoff is at least 20% of a length of the needle in the axial direction. In some embodiments, the standoff is at least 30% of a length of the needle in the axial direction.

In some embodiments, fluid is able to flow between the proximal portion of the needle and the base. The fluid may erode a portion of the base to open a leak channel to the pressure-balancing volume proximate the rear surface of the needle. In some embodiments, the pressure-balancing volume provides fluid communication to the low-pressure region via the pressure-balancing bore to lessen a pressure difference across the choke valve. In some embodiments, as described herein, the leak through the leak channel is detectable to provide a controlled and detectable failure prior to a catastrophic failure of the base holding the large diamond needle.

In some embodiments, the leak channel begins due to a machining imperfection and/or tolerance of the needle and/or base. In at least one embodiment, machining a large diamond billet to a precise dimension and/or consistent dimension across a surface of the large diamond is challenging. For example, diamond is one of the hardest materials known, and variations in surface dimensions or geometry may be difficult to control.

As described herein, the diamond joining geometries and techniques described herein are applicable to other components, such as diamond anvils, diamond nozzles, diamond cutting elements, and other diamond elements joined to non-diamond bases. In some embodiments, the large diamond billet, such as the large diamond needle, includes diamond threads on a radially outward surface of a proximal portion of the large diamond billet relative to an axial direction. In some embodiments, the diamond threads complementarily mate with base threads on the base. The threaded connection of the diamond threads and the base threads, upon torquing the threaded connection together, applies a compressive force between the needle and the base to counteract the pressure difference across the choke valve, such as described herein.

In some embodiments, the threaded connection of the needle and the base limits and/or prevents the formation of a leak channel, such as that described herein. In some embodiments, the threaded connection of the needle and the base limits and/or prevents a catastrophic failure (e.g., release) of the needle from the base. In some embodiments, a leak channel may still form, and the needle and/or base with a pressure-balancing volume and pressure-balancing bore allows the controlled failure of the choke valve and detection of the erosion prior to a catastrophic failure.

In some embodiments, the needle has diamond threads and the base has base threads. In some embodiments, the diamond threads and the base threads have substantially the same pitch but vary in shape and/or depth. In some embodiments, mating the diamond threads and the base threads plastically deforms the base threads to at least partially match the diamond threads. As machining the diamond of the large diamond needle is challenging, the base needles, in some embodiments, conform to the diamond threads and any variations therein.

In some embodiments, the diamond threads of the needle have a diamond radius of curvature (ROC) that is different from a base ROC of the base threads on the base. For example, while diamond has a relatively high toughness, the microstructure of the diamond billet may have residual strain therein, and avoidance of stress risers and stress concentrations in the large diamond needle and diamond threads is beneficial. In some embodiments, the diamond ROC is at least 10% of a diamond thread depth. In some embodiments, the diamond ROC is at least 15% of a diamond thread depth. In some embodiments, the diamond ROC is at least 20% of a diamond thread depth. In some embodiments, the diamond ROC is at least 25% of a diamond thread depth.

In some embodiments, the diamond threads of the needle have a diamond ROC that is greater than a base ROC of the base threads on the base. In some embodiments, the diamond ROC is the same at the end of the diamond threads and the troughs between the diamond threads. In some embodiments, a diamond thread depth is different from a base thread depth. In some embodiments, the diamond thread depth 650 is less than the base thread depth.

In some embodiments, the harder and tougher diamond of the diamond threads cold-works or cold-forges the metal of the base to change a shape of the base threads without heating the base threads prior to threading the connection together. In some embodiments, the base threads exhibit a cold-forged microstructure after mating to the diamond threads. In some embodiments, a ferrous base material can react with the diamond to create carbide phases in the diamond when the diamond is exposed to iron at an elevated temperature. By mating the connection and deforming the base material at ambient temperature, carbide phases can be avoided. In some embodiments, the relatively low coefficient of friction of the diamond further limits the temperature increase during the mating of the threaded connection, limiting and/or preventing the formation of carbide phases.

In some embodiments, after mating the threaded connection of the needle and the base, the base threads substantially match the geometry of the diamond threads. For example, the base thread depth changes to substantially equal the diamond thread depth. In some embodiments, a base ROC changes to substantially equal the diamond ROC.

In some embodiments, the diamond thread compresses the base thread in a radial direction, shortening the base thread. In some embodiments, compressing the base thread displaces material of the base thread in the axial direction, to form the shorter, wider base thread.

As described herein, machining diamond is challenging. Both lapping and grinding can form surfaces in the diamond billet, but cannot form detailed geometries, such as threads. In some embodiments, the diamond threads are formed in the large diamond billet by laser machining, such as laser ablation. In some embodiments, laser machining can induce heat-affected zones that graphitize the diamond. Graphitizing the diamond changes the microstructure from a cubic crystalline structure to a planar crystalline structure, substantially altering the hardness and toughness of the material. In some embodiments, the laser machining can oxidize the diamond, further damaging the microstructure.

In some embodiments, according to the present disclosure, a large diamond needle 804 is laser machined by a laser source positioned with the laser substantially tangential to the diamond thread being machined. In some embodiments, a needle and laser source are positioned such that the laser is oriented at an angle with a tangent line of less than 20°. In some embodiments, the laser is oriented at an angle with a tangent line of less than 15°. In some embodiments, the laser is oriented at an angle with a tangent line of less than 10°. In some embodiments, the laser is oriented at an angle with a tangent line of less than 5°.

In some embodiments, the substantially tangential laser machining of the diamond threads in diamond limits and/or prevents a heat-affected zone and limits and/or prevents graphitization in the heat-affected zone. However, in some embodiments, some graphitization and/or thermal strain can occur in the diamond microstructure. Abrasive blasting of the diamond threads after laser machining, in some embodiments, removes the graphitized carbon and/or relieves thermal strain in the diamond before the diamond threads are mated to the base threads, such as in any embodiments described herein. In some embodiments, the abrasive blasting includes blasting the diamond threads with a silicon carbide abrasive.

While the present disclosure describes methods of manufacturing threads in a diamond needle, it should be understood that at least some embodiments described herein may be used to manufacture threads in other large diamond billets, such as diamond anvils, diamond nozzles, diamond cutting elements, and other diamond elements joined to non-diamond bases.

As described herein, machining of diamond materials is challenging and resource intensive. In some embodiments, manufacturing and/or machining diamond to the geometry and/or dimensions of the choke valve is expensive or not possible with a given sintering press. A choke valve, in some embodiments, includes a needle and/or a seat having a plurality of monolithic diamond billets as angular segments. While the angular segments are described herein as parts of the needle, it should be understood that such description is applicable to angular segments of a seat.

In some embodiments, the angular segments are each, themselves, diamond billets. For example, each angular segment may be a large diamond billet according to the sintering methods and with the material properties described herein. The angular segments are positioned, in some embodiments, to form the needle in segments around the axial direction of the needle. The angular segments combine to form the needle circumferentially around the axial direction. In some embodiments, the needle includes at least two angular segments. In some embodiments, the needle includes a total of six segments with three angular segments illustrated in the cross-sectional view. In some embodiments, angular segments allow simpler machining of a pressure-balancing bore by machining a groove in each of the angular segments that, when assembled in the needle, form the pressure-balancing bore.

In some embodiments, the angular segments have an arcuate length relative to the axial direction. For example, the arcuate length may be measured in degrees and/or percentage of the circumference around the axial direction and perpendicular to the axial direction. In some embodiments, the arcuate length of each angular segment of the plurality of angular segments is equal. In some embodiments, an arcuate length of at least one angular segment is different from the arcuate length of a second angular segment.

In some embodiments, the angular segments contact one another interface surfaces at an angular interface. The angular interface is, in some embodiments, oriented radially to the axial direction. In such embodiments, radial compression from the base (e.g., due to differing CTEs as described herein) produces a compression between the angular segments at the angular interfaces.

In some embodiments, the interface surfaces of adjacent angular segments directly contact one another with no other materials therebetween. In some embodiments, the interface surfaces are ground, lapped, or otherwise machined to produce a smooth interface surface and a fluid-tight angular interface. In some embodiments, the interface surface has surface texture, surface features, or sintering artifacts that create one or more voids at the angular interface between angular segments. In some embodiments, the radial compression of the angular segments at the angular interface deforms the interface surface(s) to create a fluid-tight interface. In some embodiments, the voids or other space between the angular segments allows fluid flow therethrough in the axial direction such that a pressure-balancing bore is not required.

In some embodiments, a needle with a plurality of angular segments is radially compressed by a base. In some embodiments, a needle including a plurality of angular segments includes threads. For example, the diamond threads in the needle may be formed in the angular segments with at least a portion of the threads in each of the angular segments. The threads may be formed in the outer surface of the angular segments such that at least one thread is continuous between adjacent angular segments.

In some embodiments, an additional material may be located between at least at least two of the angular segments. For example, a cement or other filler material may be positioned on one or both interface surfaces at the angular interface. In some embodiments, the cement may facilitate a microstructural bond between the angular segments. In some embodiments, the cement may adhere the angular segments. In some embodiments, a filler material fills in at least one gap between the angular segments to seal the angular interface. Such cement or filler material may limit and/or prevent leakage through the angular interface and through the needle.

In some embodiments, a choke valve has a seal at a longitudinal end of the needle. The seal may be formed by deformation of a gasket material or deformation of the base material, itself. In some embodiments, the diamond threads and the base threads cooperate to apply a force in the axial direction. The axial force applies a compressive force in the axial direction between a chamfer, curved edge, or other angled edge of the needle and a circumferential edge of the base. The circumferential edge is, in some embodiment, proximate to a pressure-balancing volume or other void in the base (such as any pressure-balancing volume described herein). In some embodiments, the compressive force results in the diamond of the needle deforming the base material at the circumferential edge to create a seal that is fluid-tight and ensures any fluid flows through planned channels (such as a pressure-balancing bore).

In some embodiments, the choke valve further includes a gasket which is compressible between the needle and the base in the axial direction to further seal the thread portion and limit and/or prevent leakage. In some embodiments, the gasket includes a polymeric material. In some embodiments, the gasket includes a plastically-deformable metal. In some embodiments, the gasket is adhered to the needle. In some embodiments, the gasket is adhered to the base.

In some embodiments, a choke valve has a tapered needle thread portion to create a seal longitudinally within the thread portion. For example, the needle is tapered through at least a portion of the diamond threads in the axial direction. In some embodiments, the needle and base are tapered through at least a portion of the diamond threads and base threads, respectively, in the axial direction. In some embodiments, the tapered thread portion of the needle creates a radially-oriented compression force between the diamond threads and the base threads to concentrate the compression force and further facilitate deformation of the base threads. In some embodiments, the base is tapered in the base thread portion (e.g., the box) to concentrate the compression force and further facilitate deformation of the base threads.

In some embodiments, a choke value has a cutting face of the needle and/or base that cuts or deforms a contacting surface to create a seal. In some embodiments, a shoulder surface of the base and a flange surface of the needle contact one another to limit and/or prevent fluid flow therebetween. In some embodiments, the fluid flow therebetween is further limited by a cutting feature located on or in the flange surface. The cutting feature cuts into and/or applies a force to the shoulder surface of the base when the needle is screwed into or otherwise pressed into the base. The cutting feature may plastically or elastically deform the shoulder surface to create a fluid seal across the shoulder surface. In some embodiments, the cutting feature is continuous around a circumference of the flange surface. In some embodiments, the flange surface has a plurality of discrete cutting elements that plastically or elastically deform the shoulder surface to create a fluid seal across the shoulder surface.

In at least one embodiment of the present disclosure, a choke valve including a needle and/or seat made of a large diamond billet and/or segments made of large diamond billets has a longer operational lifetime and provides greater uptime relative to conventional steel choke valves.

The present disclosure relates to systems and methods for connecting a large diamond billet to a non-diamond base according to any of the following:
Clause 1. A device comprising: a needle including a monolithic diamond billet having a taper surface toward a distal end; and a base including a non-diamond material positioned around a proximal portion of the needle opposite the distal end in an axial direction and applying a compression force to the proximal portion of the needle.
Clause 2. The device of clause 1, wherein the monolithic diamond billet has at least one dimension greater than 10 millimeters.
Clause 3. The device of clause 1, wherein the monolithic diamond billet has a diameter greater than 10 millimeters relative to the axial direction.
Clause 4. The device of clause 1, wherein the base has a coefficient of thermal expansion greater than that of the diamond billet.
Clause 5. The device of clause 1, wherein the needle includes a deflection surface adjacent to the taper surface in the axial direction.
Clause 6. The device of clause 1, further comprising a standoff between the taper surface and the base, wherein the standoff is at least 10% of a length of the needle.
Clause 7. The device of clause 1, wherein the proximal portion is at least25% of a length of the needle.
Clause 8. The device of clause 1, further comprising a pressure-balancing volume between at least a portion of the needle and at least a portion of the base.
Clause 9. The device of clause 8, further comprising a pressure-balancing bore through the needle from the distal end to the pressure-balancing volume.
Clause 10. The device of clause 1, wherein the distal end is truncated.
Clause 11. The device of clause 1, wherein the diamond material has a flexural strength of greater than 800 MPa and a fracture toughness of greater than 8 MPa, and a diamond volume fraction greater than 90%.
Clause 12. The device of clause 1, wherein the diamond material has been subject to a stress-relieving process.
Clause 13. The device of clause 1, wherein the needle includes a plurality of angular segments relative to the axial direction.
Clause 14. The device of clause 13, wherein the angular segments of the plurality of angular segments have a uniform arcuate length.
Clause 15. The device of clause 13, wherein at least two angular segments of the plurality of angular segments directly contact one another at an interface.
Clause 16. A device comprising: a needle including a monolithic diamond billet having a distal end and a proximal portion; a base including a non-diamond material; diamond threads positioned on the proximal portion of the needle opposite the distal end in an axial direction; and base threads positioned on the base and complementarily mated to the diamond threads.
Clause 17. The device of clause 16, further comprising a pressure-balancing volume between at least a portion of the needle and at least a portion of the base.
Clause 18. The device of clause 17, further comprising a pressure-balancing bore through the needle from the distal end to the pressure-balancing volume.
Clause 19. The device of clause 16, wherein the base threads exhibit a cold-forged microstructure when mated to the diamond threads.
Clause 20. The device of clause 16, wherein the diamond threads have a diamond radius of curvature that is at least 10% of a diamond thread depth.
Clause 21. The device of clause 16, wherein the non-diamond material is a ferrous material.
Clause 22. The device of clause 16, wherein the diamond material has a flexural strength of greater than 800 MPa, a fracture toughness of greater than 8 MPa, and a diamond volume fraction greater than 90%.
Clause 23. The device of clause 16, wherein the diamond material has been subject to a stress-relieving process.
Clause 24. The device of clause 16, wherein the needle includes a plurality of angular segments relative to the axial direction.
Clause 25. The device of clause 24, wherein the angular segments of the plurality of angular segments have a uniform arcuate length.
Clause 26. The device of clause 24, wherein at least two angular segments of the plurality of angular segments directly contact one another at an interface.
Clause 27. A method of joining diamond, the method comprising: machining diamond threads in a large diamond billet; forming base threads in a base; and threading the diamond threads into the base threads.
Clause 28. The method of clause 27, further comprising deforming the base threads with the diamond threads to complementarily mate with the base threads.
Clause 29. The method of clause 28, wherein the base threads have a base thread depth that is greater than a diamond thread depth before deforming the base threads.
Clause 30. The method of clause 29, wherein the diamond threads have a diamond radius of curvature that is greater than a base radius of curvature before deforming the base threads.
Clause 31. The method of clause 27, wherein machining the diamond threads includes laser machining the diamond threads.
Clause 32. The method of clause 31, further comprising abrasive blasting the diamond threads after laser machining.
Clause 33. The method of clause 32, wherein the abrasive blasting includes blasting the diamond threads with silicon carbide.
Clause 34. The method of clause 31, wherein laser machining the diamond threads includes laser machining the diamond threads at a substantially tangential angle to a surface of the large diamond billet.
Clause 35. The method of clause 34, wherein the substantially tangential angle is less than 20° from a tangent line of the surface of the large diamond billet.
Clause 36. The method of clause 27,wherein a diamond material of the large diamond billet has a flexural strength of greater than 800 MPa and a fracture toughness of greater than 8 MPa, and a diamond volume fraction greater than 90%.
Clause 37. The method of clause 27, wherein a diamond material of the large diamond billet has been subject to a stress-relieving process.
Clause 38. A method of joining diamond, the method comprising: machining diamond threads in a diamond needle including a plurality of angular segments, wherein at least a portion of the diamond threads is located on each angular segment of the plurality of angular segments; forming base threads in a base; and threading the diamond threads into the base threads.
Clause 39. The method of clause 38, further comprising deforming the base threads with the diamond threads to complementarily mate with the base threads.
Clause 40. The method of clause 39, wherein the base threads have a base thread depth that is greater than a diamond thread depth before deforming the base threads.
Clause 41. The method of clause 40, wherein the diamond threads have a diamond radius of curvature that is greater than a base radius of curvature before deforming the base threads.
Clause 42. The method of clause 38, wherein machining the diamond threads includes laser machining the diamond threads.
Clause 43. The method of clause 42, further comprising abrasive blasting the diamond threads after laser machining.
Clause 44. The method of clause 43, wherein the abrasive blasting includes blasting the diamond threads with silicon carbide.
Clause 45. The method of clause 42, wherein laser machining the diamond threads includes laser machining the diamond threads at a substantially tangential angle to a surface of the diamond needle including a plurality of angular segments.
Clause 46. The method of clause 45, wherein the substantially tangential angle is less than 20° from a tangent line of the surface of the diamond needle including a plurality of angular segments.
Clause 47. The method of clause 38,wherein a diamond material of each angular segment of the diamond needle has a flexural strength of greater than 800 MPa and a fracture toughness of greater than 8 MPa, and a diamond volume fraction greater than 90%.
Clause 48. The method of clause 38, wherein a diamond material of each angular segment of the diamond needle has been subject to a stress-relieving process.

It should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein, to the extent such features are not described as being mutually exclusive. Numbers, percentages, ratios, or other values stated herein are intended to include that value, and also other values that are “about”, “substantially”, or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims. The described embodiments are therefore to be considered as illustrative and not restrictive, and the scope of the disclosure is indicated by the appended claims rather than by the foregoing description.

What is claimed is:

1. A device comprising:
a needle having a taper surface toward a distal end and a proximal portion opposite the distal end in an axial direction, wherein a surface of the needle includes polycrystalline diamond; and
a base including a non-diamond material positioned around the proximal portion, wherein the base is joined to the proximal portion of the needle by a compression fit.

2. The device of claim 1, wherein the needle includes a monolithic diamond billet.

3. The device of claim 2, wherein the monolithic diamond billet is a large diamond billet with at least one dimension greater than 10 millimeters.

4. The device of claim 1, wherein the compression fit is an interference fit.

5. The device of claim 1, wherein the compression fit is a shrink fit.

6. The device of claim 1, wherein the needle includes a plurality of angular segments relative to the axial direction.

7. The device of claim 6, wherein the angular segments of the plurality of angular segments have a uniform arcuate length.

8. The device of claim 1, further comprising a diamond seat configured to receive the taper surface of the needle.

9. A device comprising:
a needle having a taper surface toward a distal end and a proximal portion opposite the distal end in an axial direction, wherein a surface of the needle includes polycrystalline diamond;
a base including a non-diamond material;
diamond threads positioned in the surface including polycrystalline diamond on the proximal portion of the needle; and
base threads positioned on the base and complementarily mated to the diamond threads.

10. The device of claim 9, further comprising a pressure-balancing volume between at least a portion of the needle and at least a portion of the base.

11. The device of claim 10, further comprising a pressure-balancing bore through the needle from the distal end to the pressure-balancing volume.

12. The device of claim 9, wherein the base threads exhibit a cold-forged microstructure when mated to the diamond threads.

13. The device of claim 9, wherein the diamond threads have a diamond radius of curvature that is at least 10% of a diamond thread depth.

14. The device of claim 9, wherein the needle includes a plurality of angular segments relative to the axial direction.

15. The device of claim 14, wherein the angular segments of the plurality of angular segments have a uniform arcuate length.

16. A method of joining diamond, the method comprising:
machining diamond threads in a monolithic diamond billet;
forming base threads in a base; and
threading the diamond threads into the base threads.

17. The method of claim 16, further comprising deforming the base threads with the diamond threads to complementarily mate with the base threads.

18. The method of claim 17, wherein the base threads have a base thread depth that is greater than a diamond thread depth before deforming the base threads.

19. The method of claim 17, wherein the diamond threads have a diamond radius of curvature that is greater than a base radius of curvature before deforming the base threads.

20. The method of claim 16, wherein machining the diamond threads includes laser machining the diamond threads.

21. The method of claim 16, wherein the monolithic diamond billet is a first angular segment of a plurality of angular segments of a diamond needle, and
the method further comprising:
machining diamond threads in a second angular segment of the plurality of angular segments to form continuous diamond threads between the first angular segment and the second angular segment.

22. A method of joining diamond, the method comprising:
inserting a proximal portion of a diamond billet into a base such that at least a portion of the base is circumferentially around the proximal portion; and
compressing the proximal portion of the diamond billet with the base.

23. The method of claim 22, the method comprising:
machining a taper surface in a distal portion of the diamond billet.

24. The method of claim 23, the method comprising:
heating the base prior to inserting the proximal portion of the diamond billet into the base; and
cooling the base to produce thermal contraction of the base.
